(19) United States
(12) Patent Application Publication
(10) Pub. No.: US 2022/0071224 A1
(43) Pub. Date: Mar. 10, 2022

(54) CREAM-CHEESE-LIKE FOOD PRODUCT AND PRODUCTION METHOD

(71) Applicant: Hochland SE, Heimenkirch/Allgäu (DE)

(72) Inventors: Marie-Luise Mahler, Lindenberg (DE); Dirk Michael Herrmann-Bürk, Amtzell (DE)

(73) Assignee: Hochland SE, Heimenkirch/Allgäu (DE)

(21) Appl. No.: 17/415,905

(22) PCT Filed: Dec. 17, 2019
(86) PCT No.: PCT/EP2019/085586

§ 371 Date: Jun. 18, 2021

(30) Foreign Application Priority Data
Dec. 20, 2018 (DE) 10 2018 133 055.3

(51) Int. Cl. A23C 20/02; G01N 15/14

(52) U.S. Cl. CPC A23C 20/02; G01N 2015/1493; G01N 15/14

(57) ABSTRACT

The invention relates to a method for producing a cream-cheese-like, preferably vegan, food product with a strength measured at 10° C. by a texture testing machine, in which a round press plunger with a surface area of 1.27 cm² and a speed of 2 mm/s is introduced into a sample, said strength coming from a value range between 0.2 N and 7.0 N, preferably between 0.5 N and 2.5 N, a dry mass weight proportion between 6% and 80% and a total fat weight proportion between 0.92% and 30%, comprising the following steps: producing a pumpable mass based on water and nuts and/or seeds, preferably almonds; and obtaining the food product from the pumpable mass. The invention is characterised in that the pumpable mass is produced by mixing a partially de-oiled flour made from the nuts and/or seeds, preferably almond flour, having a fat weight proportion between 5 and 20 wt. %, with the water and fat, in particular in the form of oil.

### BACKGROUND OF THE INVENTION

The invention relates to a method for producing cream-cheese-like, preferably vegan, food products, in particular a particle suspension based on nuts and/or seeds, particularly preferably based on almonds, according to claim 1. Furthermore, the invention relates to a preferably cream-cheese-like, in particular vegan, food product based on nuts and/or seeds, preferably based on almonds.

Dietary behavior is constantly changing. Currently, there is a trend towards vegan products, such as vegan spreads, which attempt to imitate conventional, non-vegan products, such as milk-based cream cheese. In practice, this attempt has been only moderately successful so far with respect to products on the market, in particular vegan spreads based on nuts and/or seeds. On the one hand, the known substitute products differ significantly from conventional cream cheese in terms of the mouthfeel and, depending on the product, are perceived as rough or coarse-grained. Additionally, the currently offered vegan spreads based on cashews, for example, are characterized by a rather grey color effect which differs significantly from a typically white color and from a high lightness value L* in the CIELAB color space, as is the case with conventional cream cheese.

An optimized method for producing cream-cheese-like food products having a high lightness value is described in WO 2017 050 480 A1 of the applicant. The known method is characterized in that a pasty mass is first produced from dried nuts and/or seeds and is then converted into a pumpable mass by adding water and, optionally, oil. The pumpable mass is heated and simultaneously or subsequently mechanically treated, in particular high-pressure homogenized. In contrast to other known methods, this results in a product which has comparatively high lightness values, a cream-cheese-like texture and a high firmness like that of natural milk-based cream cheese. However, the variability of the fat content in the final product is limited.

Another method for producing a vegan food product based on seeds or nuts is described in EP 1 102 550 B1, for example. To produce the food product, seeds or nuts are processed while adding water to make a stirrable, pulpy substance to which oil is then added. For the final adjustment of the consistency, acid is then added to the substance resulting from the oil addition.

DE 198 34 925 C5 also describes a method for producing a vegan food product based on seeds or nuts, wherein, according to the teachings of the patent specification, a stirrable substance is produced from the comminution of seeds or nuts while adding water in a certain weight ratio; oil or liquefied fat being added to said stirrable substance, again in a specific weight ratio, wherein a final acidification is then performed to adjust the consistency.

DE 20 2007 017 700 U1 also relates to the production of cream-cheese substitute products, wherein the specification teaches the mixing of grain-free comminuted cashew seeds with soy milk in a certain proportion while stirring; said mixture is then pasteurized, cooled and acidified by adding microorganisms, whereby a substance similar to soured milk is obtained. As in the case of conventional cheese production, a liquid similar to whey is then separated from this substance and a raw mixture of the intended consistency is obtained in this way, wherein the raw mixture can be refined in terms of taste by adding spices and/or herbs. Moreover, the specification describes that a creamy consistency can be achieved by processing the raw mixture by means of a curd grinder.

GB 874 537 A describes a protein food product based on oilseed, wherein the plant protein is first separated from the contained oil. An aqueous solution of the plant protein is produced, wherein fat is added to the aqueous protein solution before it is heated. According to said teachings of the specification, the heating forms a kind of curd which can be processed in a similar manner to conventional cheese curd.

DE 20 2011 002 097 U1 also discloses a cream-cheese substitute product based on nuts. Nuts are first soaked in water for several hours and then ground into a puree, which is mixed with water, heated and then cooled again and mixed with bacteria cultures. After a ten-hour fermentation, the dry matter is set to 33% by means of water and the product is pasteurized.

U.S. Pat. No. 4,639,374 A does not relate to cream-cheese-like food products, but to an almond paste produced on the basis of almonds, sugar and emulsifiers as a basis for beverages, for example by mixing the almond paste with milk or for further processing into a dessert. In the course of the known method, the almonds are ground, wherein emulsifiers and large amounts of sugar are added during the processing, said sugar being essential for the comminution process, which is carried out on rollers, according to the teachings of the specification. In example 4, the specification mentions the use of a homomixer and a homogenizer, wherein the texture of the production result is not described. According to the specification, an oil-in-water emulsion is formed, supported by the added emulsifiers. The specification describes a possible use of almonds defatted to a small extent (50%). Since almonds usually have a natural fat content of 55% by weight, the almond material—which has a resulting residual fat content of 27.5% by weight—used in the course of the method known from the US specification has a high fat content compared to the almond flour—which has a maximum percentage by weight of fat of 20%—used in the context of the present invention.

US 2011/0064862 A1 also does not relate to cream-cheese-like products, but to the production of a nut-based milk, wherein a nut butter is mixed with water for this purpose. In such milk-like products, the focus is more on the stabilization of the products than on the structure, which differs significantly from cream-cheese-like products which are characterized by increased firmness.

DE 10 2006 037 608 A1 describes a method for producing a spread. As early as in a first step, the ingredients used are all comminuted while adding water. According to the teachings of the specification, the oilseeds used are preferably soaked in advance. As a result, the formation of large agglomerates/particles is to be expected in the known method in which the first step is not the production of a pasty mass which is then further processed into a pumpable mass in a separate step by adding water.

WO 2013/010037 A1 (EP 2731451 A1) relates to an alternative method for producing a cheese substitute product based on almonds, wherein the specification teaches that the fiber of the almonds is to be separated. The use of the cross-linked enzyme (transglutaminase) is the essential feature of the known production method.

US 2008/063752 A1 discloses a method for producing yogurt, drinking yogurt and fermented beverages, such as almond milk. A high-pressure homogenization is followed by a heating step.

EP 2 926 670 A1 discloses a method for producing a cheese substitute product which, among other things, is said to be characterized by a high fat content. In contradiction to this, the use of defatted almonds is described as one possible option. The specification does not give any information on the fat content; thus, it must be assumed that the fat content must be 0% by weight because the almonds are defatted, according to the only disclosure. To achieve this, a laborious distillation process is necessary after the addition of a fat solvent, for example hexane. Moreover, the specification does not disclose the form in which the defatted almonds are used or the point in time at which and the method by which said defatted almonds are used.

### SUMMARY OF THE INVENTION

Starting from the aforementioned state of the art, the object of the invention is to indicate a further improved method, in particular compared to the method described in WO 2017 050 480 A1, for producing a food product, more specifically a cream-cheese substitute product, based on nuts and/or seeds which, in terms of its mouthfeel, is as similar as possible to the mouthfeel created by conventional milk-based cream cheese. Particularly preferably, the method is to enable the production of food products whose lightness L* in the CIELAB color space is even more similar to a conventional cream cheese—in particular a natural, even whiter color effect is to be achieved.

Particularly preferably, the method is to be designed in such a manner that it allows/grants greater degrees of freedom with respect to the composition, in particular with respect to the selection of the type and amount of the fat/fats used.

Furthermore, the object is to indicate an improved food product, in particular as a cream-cheese substitute product.

With respect to the method, said object is attained by the features and with respect to the food product, said object is also attained by the features disclosed herein. Advantageous embodiments of the invention are disclosed herein and in the dependent claims.

In order to avoid repetitions, disclosed features relating to the method are also regarded as relating to the device and are thus claimable. In the same manner, disclosed features relating to the device are also regarded as relating to the method and are thus claimable.

In particular in contrast to the method known from WO 2017 050 480 A1 of the applicant, the concept of the invention is based on producing the pumpable mass using partially de-oiled (partially defatted) flour from nuts and/or seeds, preferably by using partially de-oiled (partially defatted) almond flour, particularly preferably only partially de-oiled (partially defatted) almond flour. To produce the pumpable mass, said flour is mixed with water and fat, in particular in the form of oil and/or solid and/or liquefied fat, wherein the total fat content of the food product according to the invention is adjusted by the addition of fat. Preferably, only vegetable fat or only vegetable fats is/are added in order to obtain a vegan cream-cheese substitute product. Usable vegetable fats and oils include, but are not limited to, for example: sunflower oil, rapeseed oil, olive oil, peanut oil, safflower oil, corn oil, almond oil and walnut oil, but also cocoa fat, coconut fat and/or palm fat. Alternatively, it is conceivable to use animal fat, for example milk fat, for at least part of the added fat, wherein the resulting cream-cheese-like product is of course no longer vegan. As will be explained later, the invention allows the added vegetable and/or animal fat to be used in a refined manner, for example bleached and/or deodorized. It is also possible to use virgin-grade fat and also a mixture of refined and virgin-grade fat in order to influence the product properties, in particular the aroma and/or taste and/or color. The absolute fat content, i.e., the total fat content of the food product according to the invention, is set to a value between 0.92% by weight and 30% by weight. Preferably, a total amount of fat or oil in the final food product, and in particular in the pumpable mass, does not exceed 6 g per gram of protein from seeds and/or nuts, in particular per gram of almond protein.

The use of partially de-oiled flour, in particular exclusively the use of partially de-oiled almond flour, surprisingly leads to an improved method and to an improved final product. There are several reasons for this. According to the method according to the invention, the production of the pumpable mass does not require the production of a pasty mass from dried, usually roasted seeds and/or nuts—instead, it is possible and preferred to use non-dried nuts and/or seeds, in particular non-dried almonds, for the production of the partially de-oiled flour. In other words, the aim of the method known from WO 2017 050 480 A1 was to limit the water content of the used seeds and/or nuts to low values, in particular to a maximum of 2% by weight, by drying, roasting and/or adding oil during the comminution. The use according to the invention of partially de-oiled flour from seeds and/or nuts allows the processing of seeds and/or nuts which have a high moisture content (water content), preferably between 4% by weight and 10% by weight. The residual moisture, i.e., the water content in the partially de-oiled almond flour, is adjusted by evaporation of water in the press cake when it is still warm and during the grinding of the press cake into flour. The preferred absence of a drying or roasting of the seeds and/or nuts, in particular almonds, used for the production of the partially de-oiled flour leads to the fact that the partially de-oiled flour used has no or at least less Maillard reaction products, i.e., among other things, a slight brown coloration, in contrast to the roasted nuts and/or seeds used according to the method described in WO 2017 050 480 A1—thus, the partially de-oiled flour used according to the invention is already characterized by a lighter coloring and a less intense nut and/or seed taste. This results in cream-cheese-like food products having higher L* values in the CIELAB color space, in particular of 80, more preferably of 82.

Furthermore, the method according to the invention allows great degrees of freedom with respect to the adjustment and composition of the total fat content. Whereas the total fat content necessarily consists entirely or at least largely of almond oil in the method known from WO 2017 050 480 A1, the method according to the invention offers the option to select the type and amount of fat within wide limits. For example, a significantly higher percentage by weight of nutritionally more valuable fat can be used. Refined and/or filtered and/or bleached and/or deodorized fat (including oil) is particularly preferably used for the production of the pumpable mass. At least 30%, preferably at least 50%, more preferably at least 90%, and particularly preferably 100% of the added fat is refined and/or filtered and/or bleached and/or deodorized.

Overall, a cream-cheese-like food product which has a whiter color effect, in particular higher L* values in the CIELAB color space, can be produced from the method according to the invention, in particular when using partially de-oiled almond flour and/or cashew flour, said cream-cheese-like product being characterized by a less intense nut and/or seed taste, in particular if the seeds and/or nuts are not dried and/or roasted in order to produce the partially de-oiled flour, and by a large proportion of nutritionally valuable fat(s) and/or treated, in particular refined and/or filtered and/or bleached and/or deodorized fat(s).

It is essential that the ingredients, in particular the amount of partially de-oiled flour and the amount of added fat (including oil), are chosen in such a manner that the resulting food product has the claimed firmness from the value range between 0.2 N and 7.0 N, preferably between 0.5 N and 2.5 N, as well as a proportion by weight of dry matter between 6% and 80%. The lower dry matter limit is preferably set to a value from a value range between 6% and 60%, more preferably to a value between 12% and 60%, particularly preferably between 15% and 40%. The upper limit of the proportion by weight of dry matter is preferably selected between 60% by weight and 80% by weight, particularly preferably between 40% by weight and <60% by weight. More preferably, the upper limit of the proportion by weight of dry matter is <40% by weight.

The total fat content and the dry matter proportion of the pumpable mass and consequently of the final product or food product can be adjusted or specified by adding the fat and the water.

It is essential that the proportions are chosen in such a manner that the resulting food product has a firmness from the claimed range, wherein the addition of hydrocolloids can be advantageous, in particular in the case of small dry matter proportions, in particular of <15% or <12%. Particularly preferably, however, no hydrocolloids are used.

In principle, no sugars have to be added, which is a preferred embodiment of the invention. Alternatively, adding sugar is possible and preferred within the scope of an alternative embodiment. Preferably, the addition is made only to adjust an intended sweetness or an intended taste profile. In particular, unlike the method described in U.S. Pat. No. 4,639,374 A, sugar is preferably not added for technological reasons, in particular not in such a manner that the sugar is used as an auxiliary means for the comminution of components. Therefore, it is also possible and preferred to add the sugar, preferably exclusively in liquid form, in particular as invert sugar. In addition or as an alternative to adding sugar in liquid form, it is possible to add sugar in powder form. A single type of sugar or several types of sugar of the following group of types of sugar is/are preferably added: sucrose, glucose, fructose, invert sugar. If sugar is added, said sugar is preferably added in a quantity between 0.1% by weight and 15% by weight in relation to the total weight of the pumpable mass. The sugar addition can be performed together with a flavoring ingredient, in particular strawberry, chocolate or a preparation. The addition of sugar is preferably performed during the production of the pumpable mass, particularly preferably before and/or during the mixing. The addition is particularly preferably performed before the heating of the pumpable mass. If liquid sugar is used, it can also be added after the hot high-pressure homogenization and/or (if provided) after the cold high-pressure homogenization.

In addition or as an alternative to adding sugar, it is conceivable to add at least one sugar substitute as a sweetener, preferably only to adjust an intended taste profile, as well.

The partially de-oiled flour from nuts and/or seeds that is used is characterized by a percentage by weight of fat between 5% by weight and 20% by weight, preferably between 10% by weight and 20% by weight, more preferably of, at least approximately, 15% by weight. The proportion by weight of protein is preferably between 43% by weight and 57% by weight, more preferably between 48% by weight and 52% by weight, particularly preferably of, at least approximately, 50% by weight. Particularly preferably, the partially de-oiled flour from nuts and/or seeds that is used has a particle size distribution which is characterized by a mean particle diameter (median of the volume distribution) ×50.3 between 50 μm and 500 μm, preferably between 100 μm and 400 μm, particularly preferably between 100 μm and 300 μm. A mean particle diameter ×50.3 of, at least approximately, 150 μm is particularly preferred. All parameters indicated in the present specification which relate to particle size distributions or particle diameters of the partially de-oiled flour used were determined in aqueous solution by means of a partica laser scattering particle size distribution analyzer LA960 of the company Horiba Scientific, in the present case at a circulation speed 2 and a stirring speed 2, wherein each sample was treated with ultrasound at strength 2 for 1 min prior to the measurement. More preferably, the partially de-oiled flour from nuts and/or seeds that is used is characterized by a water content between 4% by weight and 9% by weight, preferably of, at least approximately, 6% by weight. The pH of the partially de-oiled flour from nuts and/or seeds is preferably between 6.2 and 6.8, particularly preferably 6.5. The percentages by weight of fat or of oil indicated in the present specification were determined according to the Weibull-Stoldt VDLUFA C 15.2.3 method. The protein content or proportions indicated in the present specification were determined according to the Dumas method.

Unless otherwise stated, all following information with respect to the fat content, protein content in the present specification is based on the aforementioned analysis methods for determining the fat and protein content.

According to a preferred embodiment, the production of the almond flour can be part of the method according to the invention. To this end, almonds are preferably first blanched and almond oil is then extracted, preferably in an oil mill, until the fat content mentioned above is reached. The almond press cake obtained is ground and the partially de-oiled almond flour to be used is thus obtained.

The proposed method is also based on the realization that the cream-cheese substitute products based on nuts or seeds that are available on the market differ significantly from conventional milk-based cream cheese with respect to the structure of their microstructure level. It is assumed that this difference is the reason for the different mouthfeel of known cream cheese products compared to conventional cream cheese. It is also assumed that the microstructure, which differs from that of cream cheese, is the reason for the rather grey color effect which consumers have of known substitute products.

A microscopic analysis of known vegan cream-cheese substitute products has shown that, in contrast to conventional milk-based cream cheese, their microstructure level is not formed by a pure micro particle gel suspension in which the fat phase is completely integrated into the micro gel particles, as is the case with conventional cream cheese, but that the microscopic analysis shows that said microstructure level of known vegan cream-cheese substitute products clearly comprises a separate fat phase composed of fat droplets. Based on this realization, the method according to the invention was then developed, which is designed such that it creates microstructures in the, in particular milk-free, preferably vegan, food product according to the invention, said microstructures being comparable to the microstructures of conventional cream cheese, i.e., the fat phase being at least largely, preferably, at least approximately, completely integrated into micro gel particles.

In addition to a sufficient comminution of the fat particles and the integration of the fat phase into the micro gel particles of the food product, it is necessary according to the realization on which the invention is based to design the method such that a particle size distribution of the food product meets specific conditions (parameters) and preferably comes as close as possible to a typical particle size distribution of conventional milk-based cream cheeses. Having said that, the method according to the invention and the food product according to the invention, which is preferably cream-cheese-like and particularly preferably vegan, are explained below.

As explained above, it is essential that the pumpable mass is produced by mixing partially de-oiled flour, water and fat, wherein the mixing is carried out by stirring, for example, preferably in a cook mixer. Particularly preferably, the partially de-oiled flour is made or produced from light nuts and/or light seeds in order to also obtain a white color effect which is similar to cream cheese. Particularly preferably, only partially de-oiled almond flour is used, wherein mixtures of partially de-oiled almond flour and other partially de-oiled nut and/or seed flours can also be used within the scope of the invention, or, alternatively, almond flour can be omitted in favor of other partially de-oiled nut and/or seed flours such as partially de-oiled cashew nut and/or walnut flour and/or partially de-oiled peanut flour and/or partially de-oiled hazelnut flour, etc. The use of at least 50% by weight, more preferably at least 80% by weight of almond flour in relation to the total quantity of partially de-oiled nut and/or seed flour used is preferred. As mentioned above, the proposed method has a positive effect on the lightness L* in the CIELAB color space which is (significantly) increased if the method is performed according to the invention or in a specific manner, in particular by using partially de-oiled flour, preferably almond flour, in contrast to using a paste made of roasted nuts and/or almonds.

As described in WO 2017 050 480 A1, another essential feature of the proposed method is that, in order to obtain the food product according to the invention from the pumpable mass, said method comprises at least one heating step (warming step) and at least one mechanical processing step which are designed or to be performed such that, with respect to the structure of its microstructure level, the resulting food product corresponds at least approximately to the microstructure level of conventional cream cheese, i.e., that a large part of the fat phase, preferably at least approximately the entire fat phase is not separate, i.e. is not an independent phase visible in microscopic analysis, but is integrated into the micro gel particles of the food product, i.e., that a greatest possible or pure micro gel particle suspension is available and that the mean particle diameter ×50.3 of the food product which is not solubilized by a solvent, i.e., which is unchanged, is <100 μm, preferably between 10 μm and 40 μm, measured in distilled water, in particular by means of a laser diffraction spectrometer, which, in turn, corresponds to the mean particle diameter ×50.3 of conventional cream cheese products. It is essential that the mechanical processing is performed such that a sufficiently high pressure and/or shear force is applied to the pumpable mass to ensure the intended comminution and homogenization and integration of the fat phase into the micro gel particles. In other words, there is at least one peak, particularly preferably a global maximum of the particle size distribution of a food product according to the invention at an ×3 particle diameter of more than 10 μm.

The particle size distribution of the insolubilized, i.e., unchanged, food product according to the invention, which preferably measured or determined as described above, has at least one peak (maximum), particularly preferably a global maximum, at a particle diameter ×3>10 μm if it is sufficiently heated and mechanically processed.

As evidence that the fat phase is not present as a free phase to the desired extent, preferably at least to a large extent, more preferably completely, but that the fat phase is integrated into the micro gel particles of the food product according to the invention, another condition must be met if the heating and mechanical processing are performed correctly. In a partially solubilized state, which is obtained by mixing one part by weight of the (unchanged) food product with nine parts by weight of an SDS-EDTA solution (0.25% SDS; 0.25% EDTA), the food product must have a particle size distribution which is characterized by at least one other or additional peak at a particle diameter ×3<10 μm compared to the insolubilized food product (see above). In other words, a peak, in particular a local maximum, which does not occur in the insolubilized state, can be observed in a particle size range <10 μm in the partially solubilized state. In fact, the additional peak in the partially solubilized state is created by fat or oil droplets of the fat phase of the food product which were extracted from the micro gel particles by adding the SDS-EDTA solution and which are therefore present as a free phase and thus have an influence on the particle size distribution. Thus, the presence of the additional peak in a particle size range of <10 μm proves that the heating step and the mechanical processing step were performed according to the invention or performed correctly, i.e., that sufficient heating and sufficient mechanical stress, in particular a pressure and/or shear stress, was applied to the pumpable mass in order to at least largely integrate the fat phase into the micro gel particles.

In addition to the mechanical processing step mentioned above, (at least one) additional mechanical processing step can be performed, if required, in particular before the processing step mentioned above, particularly preferably before the heating step, in particular in order to break up and comminute fat droplets. Here, too, high-pressure homogenization is suitable, in particular, but not necessarily, if an equally high or low force is applied to the mass, i.e., in particular at an equally high or lower pressure. As a result of the realization of an additional (previous) mechanical processing step, in particular a high-pressure homogenization, the force applied in the (later or actual) mechanical processing step can be lower than in the embodiment described above which comprises only one mechanical processing step.

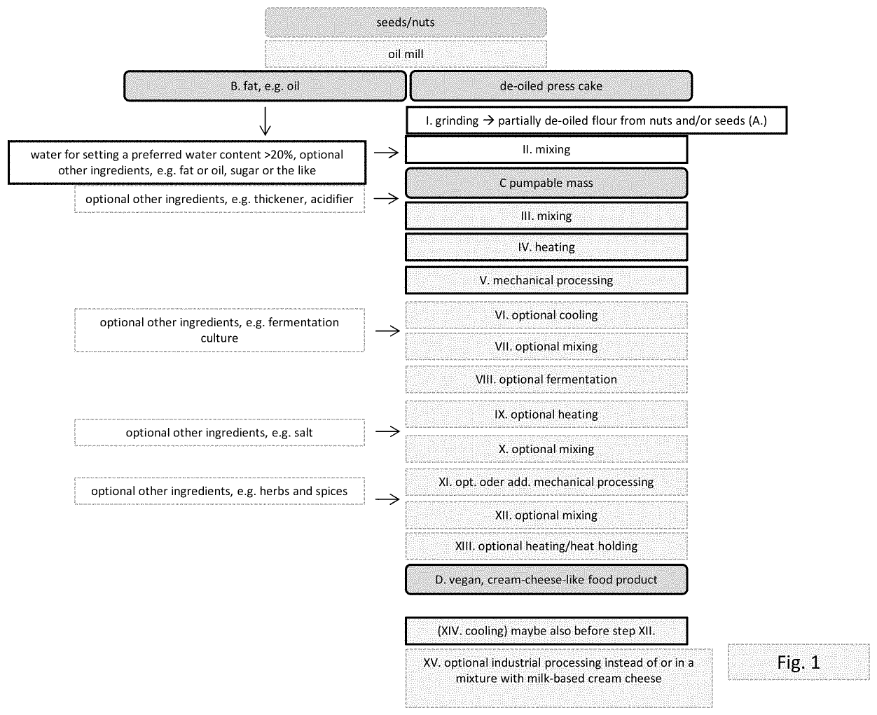

With respect to the effects of the heating step and mechanical processing step according to the invention, in particular with respect to the microstructure of the resulting food product, reference is made to the relevant explanations in WO 2017 050 480 A1 and in particular to FIGS. 1 to 4 and the associated description, which is considered to be disclosed as belonging to the present disclosure.

For a better understanding of the invention, the terms used and preferred analysis and measurement value methods are defined below:

The particle size distributions of the pumpable mass and of the food product obtained are preferably particle size distributions which are obtained by means of a laser diffraction spectrometer, i.e., semi-algorithmic density distributions of a volume-specific equivalence diameter ×3 in a particle size distribution diagram (semi-algorithmic density distribution curve) exemplarily shown in FIG. 2 in which the volume-specific equivalence diameter ×3 is plotted on the abscissa (x-axis) and the percentage frequency (particle size distribution density) of the particles is plotted on the ordinate (y-axis). In this context, particles refer to all units which can be identified by means of a laser diffraction spectrometer, i.e., both solids, agglomerates and droplets, such as fat droplets. All particle size distributions described and claimed in the application, except for the particle size distribution of the partially de-oiled flour used, were determined by means of a laser diffraction spectrometer LA-960 of the company Retsch Technology GmbH, Germany, wherein the calculation was always based on a refractive index of 1.33. The measurement of the particle size distribution of the insolubilized, i.e., unchanged, food product is carried out by dispersion of the food product in distilled water. To this end, the samples were added undiluted to the measurement cell filled with distilled water and four measurements were carried out, wherein particle agglomerates were broken up by pumping in the measurement cell until a stable measurement value is obtained. The first three measurements are used to prove that a stable measurement value has been obtained. The fourth measurement is used to determine the particle size distribution.

To obtain the food product (in order to prove the existence of the fat particles or to release/remove the fat particles) from the micro gel particles, one part by weight of a food product sample, in particular 10 g, and nine parts by weight of an SDS-EDTA solution (0.25% by weight SDS; 0.25% by weight EDTA), in particular 90 g of said solution, are solubilized by means of a magnetic stirrer at 200 rpm at room temperature for 30 min. As a result of the partial solubilization, the previously integrated fat droplets are separated from the micro gel particles and are stabilized by SDS. SDS is sodium dodecyl sulfate, i.e., an anionic surfactant, and EDTA is ethylenediaminetetraacetic acid.

The treatment with SDS/EDTA-solution must be referred to as a partial solubilization because the applied method does not result in a complete solubilization and, in addition to the fat droplets released, particles remain in the measurement suspension. For the measurement, the measurement suspension produced in this way is added to the measurement cell filled with distilled water. Here, too, four measurements are preferably carried out by means of a laser diffraction spectrometer described above in order to determine the particle size distribution, wherein the smallest particle size distribution measured is used for the interpretation.

The parameters of the particle size distributions used within the scope of the application are explained below.

×50.3 is a characteristic parameter for volume-related particle size distribution. Said particle size distribution is given in μm and means that 50% of the entire particle volume consists of particles which are smaller than the mean particle size ×50.3. Thus, the parameter ×50.3 gives an indication of the mean particle size and is referred to as such.

By analogy, the parameter ×10.3 means that 10% of the entire particle volume consists of particles which are smaller than the particle size ×10.3. Thus, this parameter gives an indication of the typical size of small particles.

Also by analogy, the parameter ×90.3 means that 90% of the entire particle volume consists of particles which are smaller than the particle size ×90.3. Thus, this parameter gives a parameter of the typical size of larger particles.

In general, the specification ×3 is a volume-specific particle equivalence diameter.

q3 (x) refers to the percentage frequency, i.e., the particle size distribution density.

For the microscopic analysis carried out within the scope of this patent application, 1 g of an insolubilized sample was mixed with 9 g of Ringer's solution in a laboratory tube and was finely dispersed via a laboratory tube shaker. The dispersion produced in this way was applied to a slide and analyzed under an optical microscope at 40× magnification.

For the analysis of partially solubilized samples, the partially solubilized dispersion was applied to a slide and analyzed under an optical microscope at 40× magnification.

Firmness measurements for the determination of the firmness were carried out by means of a texture testing machine (zwicki Z 5.0 TN, Zwick GmbH & Co. KG, Germany). For the measurements, the samples were set to 10° C. for 12 hours and only removed from the cooling just before the measurement. For the measurement, a round press plunger is introduced into the sample to a depth of 10 mm at a speed of 2 mm/s.

The maximum force absorption of the measurement sensor is indicated as the measurement value of the firmness.

A rotational viscometer (Rheomat R180, ProRheo, Germany) was used for rheological measurements. The measurement was carried out by means of a 14 mm measuring bob (measuring bob 3, ProRheo; Germany) in a sample vessel having a diameter of 55 mm. The measurement is carried out at a set speed of 50 for 1 min (measurement program 3, measuring bob 3 without gauge). A total of 20 measurement points is recorded for a period of 4 min. All samples were measured at 10° C.±2° C.

A sensory panel according to DIN 10957 was used for the sensory characterization of the preferred texture property rough-braking, wherein a low-fat curd having 20% of fat in the dry matter was used as a reference product for the property rough-braking.

Color and lightness measurements were carried out in the CIELAB color space according to EN ISO 11664-4:2011. To this end, a color spectrometer Dr. Lange spectro-color type LMG 183 was used. The values L*, a* and b* are the Cartesian coordinates of the color space defined in the DIN standard. The L* axis indicates the lightness (luminance) of the color using values from 0 to 100. The L* axis is also referred to as the neutral grey axis, because all achromatic colors (shades of grey) are included between the endpoints black (L*=0) and white (L*=100). The a* axis indicates the green or red proportion of a color, wherein negative values represent green and positive values represent red. The b* axis describes the blue or yellow proportion of a color, wherein negative values represent blue and positive values represent yellow.

As explained above, the food product according to the invention is very similar to a conventional cream cheese with respect to its microstructure, which has a particular effect on the sensory properties, in particular on the mouthfeel of the food product according to the invention. The leading attribute of conventional cream cheese types is the texture term rough-braking. By analogy with conventional cream cheese, the assessment of said sensory feature—which is to be carried out, as explained above, using a low-fat curd having 20% by weight of fat in the dry matter—is above 2.5 and preferably in a range between 3 and 7.5. A food product according to the invention or the result of the method according to the invention preferably also corresponds to the assessments of conventional cream cheese with respect to the other texture attributes of a smooth mass (reference: cold butter), quick-melting (reference: cold sour cream—minimum processing) and soft (reference: stirred cold sour cream). Here, too, the assessments are preferably in the value ranges indicated for the texture term rough-braking, wherein the other sensory analyses are also carried out according to DIN 10957.

The method step of the heating is particularly preferably performed before the mechanical processing, wherein it is useful if the pumpable mass is mechanically processed when still heated. In principle, however, it is possible to perform the heating step before and/or during the mechanical processing. It is also possible to perform the heating step exclusively before or exclusively during the mechanical processing. As will be explained below, the heating step preferably meets the conditions of a pasteurization, i.e., the heating step is performed in such a manner that the temperature to which the pumpable mass has been heated is maintained for a sufficiently long time in order to achieve a specific bacterial count result, preferably of a maximum of 1000 germs/g of food product.

With respect to the temperature selection of the heating step, different options are available. It is essential that the intended microstructure (in combination with the mechanical processing) is obtained. The invention provides that a heating to a temperature from a temperature range between 65° C. and 140° C., more preferably between 72° C. and 138° C., even more preferably between 72° C. and 90° C., is performed. According to the invention, the heating is performed before and/or during the mechanical processing. A viscosity increase relating to the heating, i.e., a comparison of the viscosity of the mass before and after the heating, can also be used as a measure of a sufficient heating step. Preferably, the heating is performed such that the heating step causes a viscosity increase of at least 100%, preferably of at least 300%. Preferably, the heating and the mechanical processing are performed together or one after the other such that the heating step and mechanical processing step cause an overall viscosity increase of at least 250%, preferably at least 500%, particularly preferably more than 600% or more than 700%.

The heating is preferably performed in a cook mixer, for example in a Stephan universal machine of the type UMC or in a Karl Schnell process automat. Alternative heating options can be realized as well. Particularly preferably, the pumpable mass is also produced in such a device by adding water.

Aligning the microstructure of the food product according to the invention with the microstructure of a conventional cream cheese allows a surprisingly good simulation or imitation of a cream cheese, not only in terms of its texture properties but also in terms of its lightness and color, i.e., in terms of the coordinates in the CIELAB color space. Preferably, a heating step and/or mechanical processing step according to the invention results in a significant or measurable increase in the lightness, i.e., in the basis coordinate L* in the CIELAB color space by an amount of at least 5, preferably by an amount from a value range between 5 and 25. In this way, a fresh or healthy visual impression of the food product according to the invention is obtained or ensured, in particular if the basis coordinate L* has a value of at least 80, in particular of at least 82, particularly preferably from a value range between 80 and 95, more preferably between 82 and 95 or higher. In principle, it was established that the particularly high lightness values can be achieved in a comparatively simple manner if the nuts and/or seeds for producing the partially de-oiled flour, for example only almonds, are selected accordingly. A corresponding selection of the nuts and/or almonds is of particular importance with respect to the setting of the other coordinates a* and b* in the CIELAB color space, because said coordinates can be influenced to a lesser extent than the lightness L* by the method according to the invention. To obtain a particularly preferred color which is as white as possible, the value a* of the food product according to the invention is preferably between −3 and +1 and/or the value b* is preferably between −1 and +9. Such a (very) white or natural cream cheese effect can in particular be achieved by selecting comparatively light nuts and/or seeds for the production of the partially de-oiled flour, for example by producing the food product, in particular exclusively, at least analogously, on the basis of partially de-oiled cashew nut flour and/or particularly preferably on the basis of partially de-oiled almond flour made of blanched or natural almonds. Blanching refers to the removal of the dark seed coat from the light almond seed.

In principle, it is advantageous if a possible dark seed coat of the nuts and/or seeds used for the production of the partially de-oiled flour is removed in order to produce the partially de-oiled flour, preferably by blanching. In other words, the partially de-oiled flour preferably does not contain components of possible dark seed coats of the nuts and/or seeds, a particularly light, uniform product thus being obtainable. Alternatively, the nuts and/or seeds used can be/remain natural in order to produce the partially de-oiled flour.

As explained above, an essential step of the method according to the invention for obtaining the food product according to the invention is the mechanical processing of the heated pumpable mass, i.e., the realization of an intensive homogenization step in the broadest sense which is primarily responsible for the intended micro structuring. In particular, the mechanical processing is to be performed in such a manner that high mechanical stress, in particular pressure and/or shear stress, is applied to the particles. An embodiment of the method in which the mechanical processing comprises a high-pressure homogenization step, for example a single-stage or multi-stage, in particular two-stage, high-pressure homogenization used for the homogenization of fresh milk, for example, has shown particularly good results. High-pressure homogenization refers to the conveying of the pumpable mass through a nozzle, for example a slot nozzle, at high pressure, in particular between 25 bar and 600 bar, particularly preferably between 100 bar and 400 bar, wherein the pressure jet hits a baffle, for example a baffle ring. Such a high-pressure homogenization can be performed as a single-stage process, which means that the entire pressure reduction is performed by means of a nozzle or in one homogenization step, or, alternatively, as a multi-stage process, in particular in such a manner that an initial pressure is gradually reduced, in particular finally to atmospheric pressure. By way of example only, a two-stage high-pressure homogenization device of the company HST-Maschinenbau GmbH called HL2.5-550K can be used for the mechanical processing step.

As an alternative to the baffle homogenization device described above, devices can be used for the performance of the mechanical processing step in which the shear force required for the high-pressure homogenization is applied to the liquid to be homogenized (pumpable mass) in that said liquid is conveyed through an interaction chamber comprising micro channels at high pressure, in particular between 100 bar and 3000 bar, preferably between 172 bar and 2068 bar, particularly preferably between 600 bar and 2068 bar or higher; in said micro channels, the liquid to be homogenized is accelerated to high speeds in order thus to generate high shear rates and forces. Such high-pressure homogenization devices for the high-pressure homogenization are available on the market under the brand name Microfluidizer of the company Microfluidics International Corporation, Westwood, USA. A device called M110EH comprising a reaction chamber of the type H30Z-G10Z has shown particularly good results.

As explained above, however, the mechanical processing is explicitly not limited to a high-pressure homogenization. Additionally or alternatively, the use of other mechanical processing methods is possible, for example by means of a dissolver described in EP 2 052 772 B1 or suitable rotor stator systems such as shear pumps, other pump nozzle systems, systems in which the product is subjected to cavitation, or systems in which the product is subjected to spontaneous relaxation under pressure.

According to a preferred embodiment, the percentage by weight of partially de-oiled flour from seeds and/or nuts, preferably exclusively almond flour, in the final food product and preferably already in the pumpable mass is between 2.63% by weight and 26.26% by weight. In the case of almond flour at an assumed protein proportion of the partially de-oiled flour of approximately 50% by weight, this results in possible protein content of 1.34% by weight to 13.34 by weight and oil content from the partially de-oiled flour of 0.37% by weight to 3.70% by weight in the final food product and preferably already in the final pumpable mass. Depending on the amount used of partially de-oiled flour, an addition of fat, in particular in the form of oil, of 0.55% by weight to 29.63% by weight is possible at a targeted fat content of the final product of 0.92% by weight to 30.0% by weight. The total proportion of almond oil in the food product and preferably already in the pumpable mass can be 0% to 100% of the fat added.

At an almond flour proportion of 2.63% by weight to 6.49% by weight it should be taken into account, according to a preferred embodiment, that at least 0.01% by weight to 3.37% by weight of pure fat (as in the entire specification, this includes oil) from whatever source is to be added in order to obtain a dry matter of at least 6.0%. At a targeted absolute fat content of 20% by weight, for example, the use of a total of 16.30% by weight to 19.63% by weight of fat from one or any number of different sources could be realized.

As mentioned above, the exclusive use of almond flour as partially de-oiled flour is particularly preferred. If, for example, the partially de-oiled almond flour and almond oil is mixed in a preferred ratio of 52.52 to 47.48, the typical composition of almonds is obtained. If, for example, the almond flour contains approximately 50.8% of protein and still a residual fat content of 14.1%, the natural ratio of 1:2, i.e., 50%, of almond protein to almond oil in almonds is achieved.

According to a preferred embodiment, partially de-oiled almond flour and almond oil are used in the ratio in which they occur naturally in almonds as almond protein and almond oil, in particular in the case of an exclusive use of partially de-oiled almond flour as the partially de-oiled flour used. This ratio is 52.52% of almond flour and 47.48% of almond oil. At a preferred almond flour proportion of 2.63% to 26.26% by weight, 0.37% by weight to 3.70% by weight of oil come from the almond flour and 2.37% by weight to 23.74% by weight of almond oil and 0% by weight to 27.26% by weight of fat or oil from other sources are used; the fat or oil can come from one or several alternative plant or animal sources. At a more preferred almond flour proportion of 5.25% by weight to 10.50% by weight, 0.74% by weight to 1.48% by weight of oil come from the almond flour and 4.75% by weight to 9.50% by weight of almond oil and 0% by weight to 24.51% by weight of fat or oil from one or several alternative fat sources are used. This results in a possible absolute fat content of 5.49% by weight to 30% by weight. Particularly preferably, an almond flour proportion between 7.88% by weight to 10.50% by weight and a fat content between 15.0% by weight to 25.0% by weight is chosen. This can be achieved by the combination of 7.12% by weight to 9.5% by weight of almond oil and 4.02% by weight to 16.77% by weight of fat or oil from alternative sources, because 1.11% by weight to 4.48% by weight of oil are already added via the almond flour. The particularly preferred dry matter is between 15.0% by weight and 40.0% by weight.

The following table shows three different embodiments, wherein a preferred, a more preferred and a particularly preferred variant are listed one below the other for each embodiment. The protein content was calculated assuming a protein content of 50% by weight in the partially de-oiled almond flour used—depending on the flour quality, the actual protein content may be slightly different. All percentages in the table and in the entire disclosure are percentages by weight.

In the first embodiment, the final food product and preferably already the pumpable mass contain almond flour and almond oil in the natural ratio explained above. In the second embodiment, exclusively almond oil is used as a fat source. In the third embodiment, no additional or added almond oil is used in addition to the almond oil still contained in the partially de-oiled flour. The three disclosed embodiments and their respective three sub-embodiments (from top to bottom: preferred, more preferred, particularly preferred) are also seen as relating to the invention and are thus also claimable therefore, wherein, as mentioned above, the protein content of the specified fat content may vary from the specified values or can be calculated on the basis of the actual ratio of fat and protein in the partially de-oiled almond flour.

| | | | oil | added | | Additional | |
|---|---|---|---|---|---|---|---|
| | | | content | almond oil | | possible | |
| | almond | | from the | proportion | total | oil/fat from | Absolute |
| | flour | protein | almond | for natural | almond | alternative | fat |
| | proportion | content | flour | ratio | oil | sources | content |
| | [%] | [%] | [%] | [%] | [%] | [%] | [%] |
| almond flour | 2.63-26.26 | 1.34-13.34 | 0.37-3.70 | 2.37-23.74 | 2.74-27.44 | 0-27.26 | 2.74-30.0 |
| and almond oil | 5.25-10.50 | 2.67-5.33 | 0.74-1.48 | 4.75-9.50 | 5.49-10.98 | 0-24.51 | 5.49-30.0 |
| in natural ratio | 7.88-10.5 | 4.00-5.33 | 1.11-1.48 | 7.12-9.5 | 8.23-10.98 | 4.02-16.77 | 15.0-25.0 |
| only almond oil | 2.63-26.26 | 1.34-13.34 | 0.37-3.70 | 2.37-23.74 | 2.74-27.44 | 0 | 2.74-30.0 |
| as a fat source | 5.25-10.50 | 2.67-5.33 | 0.74-1.48 | 4.75-9.50 | 5.49-10.98 | 0 | 5.49-26.65 |
| | 7.88-10.5 | 4.00-5.33 | 1.11-1.48 | 7.12-9.5 | 8.23-10.98 | 0 | 8.23-26.65 |
| no use of | 2.63-26.26 | 1.34-13.34 | 0.37-3.70 | 0 | 0.37-3.70 | 0.55-29.63 | 0.92-30.0 |
| additional almond | 2.63-6.5 | 1.34-3.30 | 0.37-0.92 | 0 | 0.37-0.92 | 3.37-0.01 | 0.93-3.74 |
| oil as a fat source | 2.63-26.26 | 1.34-13.34 | 0.37-3.70 | 0 | 0.37-3.70 | 16.30-19.63 | 20 |

In the same manner, the embodiments mentioned above are also seen as disclosed if said embodiments use a partially de-oiled flour made of almonds, different nuts and/or seeds, for example of cashew nuts, sunflower seeds, etc., in addition or as an alternative to de-oiled almond flour. In this case, the last parameter column is essential as the target, i.e., the absolute fat content of the food product, wherein, in this case, the column oil content from the almond flour represents the oil content of the partially de-oiled flour used. From this, the first column (i.e. the flour proportion) and the protein content can then be calculated, wherein the protein content of the partially de-oiled flour used has to be determined or known for this purpose. To calculate the fourth parameter column, which must be titled “added nut and/or seed oil proportion of the nuts and/or seeds used for the production of the flour used for natural ratio” in this case, is then calculated on the basis of the respective natural ratio of protein to fat of the flour used. The sixth parameter column describes possible added fat from sources other than those of the seeds and/or nuts used for the production of the flour. In other words, embodiments in which no or not exclusively partially de-oiled almond flour but partially de-oiled flour from almonds, different seeds and/or nuts is used are also seen as disclosed and are thus also claimable therefor, wherein the partially de-oiled flour used and the associated oil, i.e., oil from the same source or the same type of seeds and/or nuts from which the flour was produced, are preferably used in the respective natural ratio—with or without the addition of fat from at least one other source. It is also possible to add only fat from the same source or no fat from the same source.

Particularly preferably, the pH of the food product is set to a value<5.5, preferably from a value range between 4 and 5.4. The setting of the pH primarily serves to improve the shelf life and to influence the protein denaturation and swelling in a positive way in order to improve the simulation of the properties of a conventional cream cheese. The acidification explicitly does not serve to adjust the consistency or the rheological properties, in particular because a corresponding influence of the acidification is substantially lower than the influence of the heating and of the mechanical processing—in particular, by way of example, a possible influence on a consistency increase in the case of direct acidification of the pumpable mass is less than 15% of the absolute viscosity increase when the method according to the invention is applied.

With respect to the time of the acidification and to the acidification method, different options are available. The pumpable mass can be acidified, namely before and/or during and/or after the heating and/or (before and/or during and/or after) the mechanical processing. In principle, the acidification can be performed by adding an acid which is approved or suitable for food products, such as citric acid and/or acetic acid. Additionally or alternatively, an acidification can be performed by adding microorganisms and by a corresponding fermentation, wherein it is possible in principle to perform said fermentation at different method stages. Thus, the fermentation of the pumpable mass can be performed before or after the heating and before or after the mechanical processing.

In the preferred case that a heating is performed before the fermentation or bacteria addition, the mass is first cooled to a temperature <45° C. and preferably to a temperature from a value range between 16° C. and 44° C. It is also possible to perform an acidification by adding an acidic food product such as lemon juice or vinegar.

If the acidification is performed using microorganisms, one or several of the following species is or are preferably used: Streptococcus thermophilus; Lactobacillus delbrueckii ssp. bulgaricus; Lactobacillus delbrueckii ssp. lactis; Lactobacillus delbrueckii ssp. delbrueckii; Lactobacillus acidophilus; Lactobacillus plantarum; Lactobacillus rhamnosus; Lactobacillus casei; Lactobacillus paracasei; Lactobacillus buchneri; Lactobacillus parabuchneri; Lactococcus lactis ssp. cremoris; Lactococcus lactis ssp. lactis; Lactococcus lactis ssp. lactis biovar. diacetylactis; Leuconostoc lactis; Leuconostoc mesenteroides ssp. cremoris; Leuconostoc mesenteroides subsp. mesenteroides; Bifidobacterium lactis.

As mentioned above, the heating step is particularly preferably performed in a cook mixer, for example in a Stephan universal machine, in particular of the type UMC, or, alternatively, in a Karl Schnell process automat in which a mechanical processing is already performed.

As also mentioned above, the heating step is preferably performed as a pasteurization step, preferably at a temperature between 65° C. and 140° C. and/or a heat holding time of less than 3600 s, or at least in such a manner that the bacterial count of the final food product is <1000 per gram.

If necessary, salt can be added to produce the pumpable mass or the final pumpable mass (the latter before and/or during and/or after the heating, and/or before and/or during and/or after the mechanical processing), in particular in such a quantity that the salt content of the food product is between 0.05% by weight and 4% by weight, particularly preferably between 0.1% by weight and 2% by weight. If necessary, other or alternative ingredients can be added to produce the pumpable mass or the final pumpable mass.

For example, herbs and/or spices and/or nuts and/or cocoa and/or sugar and/or vegetables and/or fruits can be added as other or alternative products, in particular in such a total quantity that the total proportion by weight of the other ingredients in the final food product is between 0.01% by weight and 25% by weight.

Moreover, a thickener which is approved for food products, in particular according to the regulation on the approval of additives, in particular locust bean gum, can preferably be added during the method, preferably for the purposes of texture adjustment and/or dry matter exchange. The total proportion by weight of thickeners in the final food product is preferably between 0.01% by weight and 25% by weight. It is also possible that thickeners are left out completely.

At least one emulsifier, preferably according to the regulation on the approval, can also be added during the method, in particular at a total proportion by weight in the final food product between 0.01% and 25%, for the purposes of further optimization of the fat droplet comminution and fat droplet integration. The use of an emulsifier usually leads to additional stabilization of the small droplets produced in the mechanical step; said little droplets then appear as an additional peak at a particle size <10 μm in the partially solubilized state. Preferably, no emulsifiers are used.

It is particularly useful if the heating and in particular the mechanical processing are performed in such a manner that the particle size distribution of the food product in the insolubilized state has a ×10.3 particle diameter from a value range between 5 μm and 15 μm and/or a ×90.3 particle diameter from a value range between 20 μm and 75 μm.

Furthermore, the invention relates to a food product which is characterized by the particle size parameters explained above in the context of the method according to the invention, in particular by a preferred mean particle diameter ×50.3<100 μm, preferably between 10 μm and 40 μm, in the insolubilized state and by at least one peak, in particular a global maximum in the particle size distribution at a volume-specific particle diameter (equivalence diameter) ×3<10 μm. An additional peak in a size range <10 μm can be observed in the partially solubilized state compared to the insolubilized state.

It is essential that the food product according to the invention resulting from the method according to the invention is characterized in that it contains partially de-oiled flour from nuts and/or seeds, in particular partially de-oiled almond flour. Particularly preferably, the proportion of partially de-oiled almond flour in relation to the total quantity of partially de-oiled flour is at least 50% by weight, more preferably at least 80% by weight, wherein it is particularly preferred if the food product according to the invention contains exclusively partially de-oiled almond flour as flour. The cream-cheese-like food product according to the invention is characterized by a firmness from a value range between 0.2 N and 7.0 N, preferably between 0.5 N and 2.5 N, wherein, with respect to the measurement or analysis method, reference is made to the explanations above in the description of the method. The proportion by weight of dry matter is between 6% by weight and 80% by weight. With respect to advantageous embodiments of the proportion by weight of dry matter, reference is also made to the explanations above in the method description. The total proportion by weight of fat of the food product according to the invention is between 0.92% by weight and 30% by weight.

As the first essential method steps A and B, partially de-oiled flour from nuts and/or seeds, in particular exclusively from almonds, and fat, in particular in the form of oil and/or liquefied fat, are provided, wherein a liquefaction takes places at the latest at heating step IV or preferably before heating step IV already during the production of the pumpable mass by choosing an appropriate temperature. Preferably, the production of the partially de-oiled flour is not directly part of the method, i.e., the partially de-oiled flour is preferably obtained, in particular from an oil mill in which oil is extracted from the nuts and/or seeds, in particular by pressing. However, if necessary, the production of the partially de-oiled flour can be part of the method—in this case, a de-oiled press cake is preferably first produced from nuts and/or seeds, which is then ground.

In any case, as another essential method step, pumpable mass C is produced by mixing (step II) the partially de-oiled flour (A) of the fat (B) and water (see left column), wherein the water content is preferably set to at least 20% by weight.

The advantageous embodiments explained below in the context of the food product also influence advantageous embodiments of the method by adding corresponding ingredients, selecting method steps and/or setting ratios in a corresponding manner in the method. Of course, the same applies vice versa; advantageous embodiments or variants of the method can lead to embodiment variants of the food product according to the invention which may not be explicitly explained, but which can be claimed.

Specific examples of preferred uses or applications are the use as a spread or as a filling or recipe component of pastry products or confectionery or antipasti or noodles or as a component of delicatessen salads or sauces or dressing, as use in ice cream or, in particular pure, for use as a cheese substitute, in particular cream cheese substitute.

A use as a raw material or recipe component of other cheese substitutes, such as substitutes for white cheese, mozzarella and hard and semi-hard cheese, is also possible.

It is also possible to add animal products such as cream or butter to the food product during its production, in particular in order to set the fat content, and/or to use the food product as an addition to food products containing butter or cream. In this case, of course, the food product is not vegan.

### BRIEF DESCRIPTION OF THE DRAWINGS

The possible embodiment of a method according to the invention comprising a plurality of optional method steps is explained below on the basis of the block diagram according to FIG. 1.

### DETAILED DESCRIPTION

Ingredients such as fat, oil and/or sugar can optionally be added. If necessary, other ingredients such as thickeners, for example locust bean gum, and/or acidifiers such as citric acid and/or acetic acid can be added to the pumpable mass. An (additional) mixing step III and a heating step IV and a mechanical processing V, preferably a high-pressure homogenization, are then performed. Steps II to IV and, if applicable, steps IV to IX to be explained below or some of these steps can be performed in a cook mixer, for example.

The amount of water, the amount of fat and the amount of facultative other ingredients is preferably chosen in such a manner that the total proportion by weight of fat is between 0.92% by weight and 30% by weight, in particular between 5% and 30%, more preferably between 15% and 25% and/or that the proportion by weight of dry matter is between 6% and 80%, in particular between 12% and 60%, more preferably between 15% by weight and 40% by weight.

The heating step must be performed before and/or during the mechanical processing. In any case, the heating and mechanical processing result in a food product according to the invention which is preferably vegan and cream-cheese-like (see D).

A plurality of optional method steps which are apparent from the block diagram can be realized, preferably after the mechanical processing; said method steps can be performed individually or in any combination and are claimable. For example, a fermentation culture can be added in addition or as an alternative to a previous acid addition after an optional cooling after the mechanical processing in order to acidify the food product, wherein a mixing according to step VII is optionally performed in this case and then an optional fermentation according to step VIII. To inactivate the microorganisms, a heating step IX can then be optionally performed and, if necessary, other ingredients such as salt can then be added. If said other ingredients such as salt are added, an optional mixing is performed in step X.

If necessary, other or alternative ingredients such as herbs or spices can be added and/or another additional mechanical processing can be performed, for example an additional high-pressure homogenization, if a specific particle/fat distribution is to be achieved.

The food product is preferably cooled (see step XIV), in particular if this has not yet been done.

An exemplary recipe/method designed according to the idea of the invention is as follows:

| parameter/ | proportion in recipe |
|---|---|
| ingredients | [% by weight] |
| water | 67.5 |
| almond flour | 10.5 |
| almond oil | 9.5 |
| total almond | 20 |
| coconut oil | 11 |
| table salt | 0.75 |
| thickener | 0.5 |
| acidifier | 0.25 |

To produce the pumpable mass, salt is generally preferably added, as well as citric acid, and the salt is added in such a quantity that the total proportion by weight of salt in the final food product is 0.75% by weight and the proportion by weight of citric acid is 0.25% by weight.

The pumpable mass obtained in this way is heated to a temperature of 85° C. in a cook mixer, wherein said temperature is kept for 120 s.

A two-stage high-pressure homogenization is performed after the heating, wherein the pressure is reduced by 400 bar in the first pressure stage and by 80 bar in the second pressure stage.

This is followed by a cooling to room temperature, after which cream cheese cultures are added and a fermentation takes place.

1-15. (canceled)

16. A method for producing a cream-cheese-like food product having a firmness corresponding to the maximum force absorption of the force transducer from a value range between 0.2 N and 7.0 N, measured at 10° C. by means of a texture testing machine in which a round press plunger having an area of 1.27 cm² is introduced into a sample kept at a temperature of 10° C. for 12 h at a speed of 2 mm/s, a proportion by weight of dry matter between 6% and 60% and a total proportion by weight of fat between 0.92% and 30%, the method comprising the steps of
producing a pumpable mass based on water and fat, and nuts and/or seeds;
obtaining the food product from the pumpable mass by heating to a temperature from a temperature range between 65° C. and 140° C., and mechanical processing in such a manner that
in an insolubilized state, the obtained food product has a particle size distribution which is characterized by a mean particle diameter ×50.3<100 μm, and by at least one peak, at a particle diameter ×3>10 μm, measured in distilled water by means of a laser diffraction spectrometer,
the heating step being performed before and/or during the mechanical processing,
the pumpable mass is produced by mixing partially de-oiled flour with the water and the fat, without first producing a pasty from seeds and/or nuts, the de-oiled flour being made of the nuts and/or seeds, which has a proportion by weight of fat between 5% by weight and 20% by weight and a water content between 4% by weight and 9% by weight.

17. The method according to claim 16, wherein the food product is a vegan food product, the food product has a firmness corresponding to the maximum force adsorption of the force transducer from a value range between 0.5 N and 2.5 N, wherein the fat is in the form of oil and the pumpable mass is based on almonds.

18. The method according to claim 16, wherein the temperature range is between 72° C. and 140° C., the mean particle diameter is between 10 μm and 40 μm and the at least one peak is a global maximum.

19. The method according to claim 16, wherein for producing the pumpable mass, the partially de-oiled flour is added in such an amount that the percentage by weight of the partially de-oiled flour in the food product is between 2.63% and 26.26%.

20. The method according to claim 19, wherein the partially de-oiled flour is almond flour and the percentage by weight of the partially de-oiled flour in the food product is between 5.25% and 10.50% or between 2.63% and 6.50%.

21. The method according to claim 20, wherein the percentage by weight of the partially de-oiled flour in the food product is between 7.88% and 10.50%.

22. The method according to claim 16, wherein the partially de-oiled flour has a particle size distribution which is characterized by a mean particle diameter ×50.3 between 50 μm and 500 μm.

23. The method according to claim 22, wherein the mean particle diameter ×50.3 is between 50 μm and 150 μm.

24. The method according to claim 16, wherein the added fat consists only of almond oil.

25. The method according to claim 16, wherein the added fat contains almond oil or consists of almond oil, the total proportion of almond oil in the food product thus being between 0.92% by weight and 30.0% by weight, or wherein the added fat does not contain almond oil and the proportion of almond oil resulting from the partially de-oiled almond flour in the food product is between 0.37% by weight and 3.70% by weight.

26. The method according to claim 16, wherein the fat is added in the form of oil and/or is heated during the production of the pumpable mass in such a manner that it is liquid in the pumpable mass.

27. The method according to claim 16, wherein at least a percentage by weight of the added fat is refined and/or filtered and/or bleached and/or deodorized.

28. The method according to claim 16, wherein the heating and/or the mechanical processing is performed in such a manner that the color of the food product is defined in the CIELAB color space with the Cartesian basis coordinates L*, a*, b* according to EN ISO 11664-4:2011 by L*≥80, and/or a* between −3 and +1 and/or b* between −1 and +9 and/or in such a manner that L* is increased by at least 5, by the heating and/or the mechanical processing in the CIELAB color space with the Cartesian coordinates L*, a*, b*, according to EN ISO 11664-4:2011.

29. The method according to claim 16, wherein the partially de-oiled flour does not contain roasted and/or dried nuts and/or seeds.

30. The method according to claim 16, wherein the pH of the food product is set to a value of less than 5.5 and/or from a value range between 4 and 5.4.

31. The method according to claim 30, wherein the pH of the food product is set by acidifying the pumpable mass before and/or during and/or after the heating.

32. The method according to claim 16, wherein sugar having a percentage by weight between 0.1% and 15% in relation to the total weight of the pumpable mass is added for setting a desired flavor profile.

33. A food product obtained by a method according to claim 16, wherein, in an insolubilized state, the cream-cheese-like food product has a particle size distribution which is characterized by a particle size distribution having a mean particle diameter ×50.3<100 μm, and by at least one peak, at a particle diameter ×3>10 μm, measured in distilled water by means of a laser diffraction spectrometer, and wherein, in a partially solubilized state which is obtained by mixing one part by weight of the food product with nine parts by weight of an SDS-EDTA-solution (0.25% SDS, 0.25% EDTA), and wherein the food product has a firmness corresponding to the maximum force absorption of the force transducer from a value range between 0.2 N and 7.0 N measured at 10° C. by means of a texture testing machine in which a round press plunger with an area of 1.27 cm² is introduced into a sample kept at a temperature of 10° C. for 12 h at a speed of 2 mm/s, and wherein the proportion by weight of dry matter is between 6% and 60% and the total proportion by weight of fat is between 0.92% and 30%,
wherein
the food product contains partially de-oiled flour from nuts and/or seeds having a percentage by weight between 2.63% and 26.26%.

34. The food product according to claim 33, wherein the food product contains refined and/or filtered and/or bleached and/or deodorized fat.

35. The food product according to claim 33, wherein the food product contains only almond oil as a fat or a proportion of non-almond fat in addition to a proportion of almond oil and/or wherein the food product contains only fat from such seeds and/or nuts from which the partially de-oiled flour is produced or wherein, in addition to a proportion of such a fat, the food product contains a proportion of fat from at least one other source.

36. A use of a food product according to claim 33 as a recipe component in an industrially produced food.

37. The method as claimed in claim 16, wherein the mechanical processing is carried out in such a manner that in a partially solubilized state, which is obtained by mixing one part by weight of the food product with nine parts by weight of an SDS-EDTA-solution (0.25% SDS; 0.25% EDTA), the food product has a particle size distribution which has at least one additional peak at a particle diameter ×3<10 μm compared to the insolubilized state, measured in distilled water by means of a laser diffraction spectrometer.

38. The food product according to claim 33, wherein the food product has a particle size distribution which has at least one additional peak at a particle diameter ×3<10 m compared to the insolubilized state, measured in distilled water by means of a laser diffraction spectrometer.
